(19) United States
(12) Patent Application Publication
(10) Pub. No.: US 2007/0119480 A1
(43) Pub. Date: May 31, 2007

(54) Apparatus and method of supplying chemical solution

(76) Inventors: Tae-Young Nam, Seoul (KR); Wang-Keun Kim, Yongin-si (KR); Sang-Gon Lee, Hwaseong-si (KR); Young-Seok Roh, Suwon-si (KR); Ho-Wang Kim, Seoul (KR); Jin-Won Kim, Yongin-si (KR); Hyung-Geuk Kim, Seongnam-si (KR)

Correspondence Address: F. CHAU & ASSOCIATES, LLC, 130 WOODBURY ROAD, WOODBURY, NY, 11797, US

(21) Appl. No.: 11/498,302

(22) Filed: Aug. 2, 2006

(30) Foreign Application Priority Data
Aug. 3, 2005 (KR) 2005-71138

(51) Int. Cl. B08B 9/00

(52) U.S. Cl. 134/22.1

(57) ABSTRACT

An apparatus for supplying a chemical solution includes a mother tank storing a chemical solution, an intermediate tank disposed in a higher position than the mother tank with a first height difference (h), and the intermediate tank is adapted to receive a fixed amount of chemical solution from the mother tank. The apparatus further includes a bubbling tank disposed in a higher position than the intermediate tank with a second height difference (h′) and the bubbling tank is adapted to receive the fixed amount of the chemical solution from the intermediate tank.

### CROSS-REFERENCE TO RELATED APPLICATION

This application claims priority from Korean Patent Application No. 10-2005- 0071138, filed Aug. 3, 2005, the disclosure of which is hereby incorporated by reference herein in its entirety.

### BACKGROUND OF THE INVENTION

1. Technical Field

The present disclosure relates to an apparatus and method of fabricating a semiconductor device, and more particularly, to an apparatus and method of supplying a chemical solution, capable of supplying a fixed amount of chemical solution used in a semiconductor fabricating process.

2. Description of the Related Art

Generally, a chemical solution used in a semiconductor fabricating process is supplied after it is changed from a liquid phase to a gaseous phase in a bubbler or a vaporizer.

An example of a conventional apparatus for supplying a chemical solution includes two intermediate tanks (e.g. buffering tanks) installed between a chemical supplying tank and a process chamber. This apparatus may supply a chemical solution to the process chamber by pressurizing the tanks with helium and continuously filling a pipe with a chemical solution. Moreover, the above-mentioned conventional chemical-solution supplying apparatus is mainly for general use purposes and typically supplies chemical solutions, such as, for example, tetraethylorthosilicate (TEOS), triethylborate, triethylphosphate (TEPO), or titaniumtetrachloride (TiCl₄).

Another example of a conventional apparatus for supplying a chemical solution includes a separate container at main equipment. This type of apparatus may be used to directly supply a chemical solution having a high vapor pressure like, for example, a tetrakisdemethylamidotitanium (TDMAT) chemical solution to a process chamber.

However, the above-mentioned conventional chemical-solution supplying apparatuses adopt a method of continuously supplying a chemical solution regardless of the amount of chemical solution. Also, the aforementioned chemical solutions supplied by the above conventional apparatuses are generally in a liquid phase with potentially dangerous properties such as, for example, combustibility, corrosiveness, and/or toxicity. For at least the above-mentioned reasons, a buffering device should be considered for use in conjunction with chemical-solution supplying apparatuses. Accordingly, to prevent process accidents due to excessive supply of chemical solutions, there is a need for an improved chemical solution supplying apparatus and method which may stably supply a fixed amount of chemical solution.

### SUMMARY OF THE INVENTION

In accordance with an exemplary embodiment of the present invention, an apparatus for supplying a chemical solution is provided. The apparatus may include a mother tank storing a chemical solution, an intermediate tank disposed in a higher position than the mother tank with a first height difference (h), and a bubbling tank disposed in a higher position than the intermediate tank with a second height difference (h′). The intermediate tank is adapted to receive a fixed amount of chemical solution from the mother tank. Moreover, the bubbling tank is adapted to receive the fixed amount of chemical solution from the intermediate tank.

In some exemplary embodiments, the initial pressure (P_{MT}) of the mother tank (MT) may be set by the following equation P_{MT}=Chemical pressure due to the first height difference (h)+Push pressure of the intermediate tank (IT). Here, the Push pressure of the intermediate tank (IT) is the pressure of a chemical solution, which is applied to the mother tank (MT) from the intermediate tank (MT) when the chemical solution occupies a certain portion of the intermediate tank (IT).

In other exemplary embodiments of the present invention, the initial pressure (P_{IT}) of the intermediate tank (IT) may be set by the following equation P_{IT}=Push pressure of the intermediate tank (IT)×{V_{IT} (empty space)/VIT}. Here, the V_{IT} (empty space) is the volume of an empty space of the intermediate tank (IT) which is filled with no chemical solution, and the V_{IT} is the entire volume of the intermediate tank (IT).

In other exemplary embodiments, the initial pressure (P_{BT}) of the bubbling tank (BT) may be set by the following equation P_{BT}={Initial pressure (P_{IT}) of the intermediate tank (IT)−Chemical pressure due to the second height difference (h′)}×{V_{BT} (empty space)/V_{(BT+h′pipe)}}. Here the V_{BT} is the volume of an empty space of the bubbling tank (BT) which is filled with no chemical solution, and the V_{(BT+h′pipe)} is the sum of the entire volume of the bubbling tank (BT) and the volume of a pipe between the bubbling tank (MT) and the intermediate tank (IT).

In yet other exemplary embodiments of the present invention, the intermediate tank (IT) may be refilled with a chemical solution remaining in a pipe between the intermediate tank (IT) and the bubbling tank (BT). The mother tank (MT) may be refilled with a chemical solution remaining in a pipe between the mother tank (MT) and the intermediate tank (IT).

In further exemplary embodiments of the present invention, a solvent tank storing a solvent for washing a pipe between the mother tank (MT) and the intermediate tank (IT) may be further included. A waste tank storing a solvent to be discarded after washing the pipe may be further included.

In other exemplary embodiments of the present invention, the chemical solution may be TMA (trimethylaluminum) or TEMAH (tetrakismethylaminohafnium).

In further exemplary embodiments of the present invention, the intermediate tank (IT) may include a pipe through which an inert gas is supplied thereto so that the pressure of the intermediate tank (IT) increases. The pipe through which the inert gas is supplied may include a unit that measures the pressure of the intermediate tank (IT). The intermediate tank (IT) may include an ultrasonic sensor that checks whether or not a chemical solution exists. The intermediate tank (IT) is formed of or surface-treated with a Monel™ alloy.

In yet further exemplary embodiments of the present invention, the mother tank (MT) may be formed in plurality. The bubbling tank (BT) may be formed in plurality.

In other exemplary embodiments of the present invention, a method of supplying a chemical solution using a mother tank storing a chemical solution, an intermediate tank disposed in a higher position than the mother tank with a first height difference (h), and a bubbling tank disposed in a higher position than the intermediate tank with a second height difference (h′) is provided. The method includes setting the mother, intermediate and bubbling tanks at respective initial pressures. The method further includes providing a specific amount of chemical solution from the mother tank to the intermediate tank by maintaining the mother tank at the initial pressure of the mother tank and changing the pressure of the intermediate tank to a first pressure higher than the initial pressure of the intermediate tank. Additionally, the method further includes providing the specific amount of chemical solution from the intermediate tank to the bubbling tank by changing the pressure of the intermediate tank from the first pressure to the initial pressure of the intermediate tank and changing the pressure of the bubbling tank to a second pressure higher than the initial pressure of the bubbling tank. Moreover, the method further includes refilling the intermediate tank with a chemical solution existing in a pipe between the bubbling tank and the intermediate tank by changing the pressure of the bubbling tank to a third pressure lower than the second pressure and setting the intermediate tank at a vacuum. Also, the method further includes refilling the mother tank with a chemical solution existing in a pipe between the intermediate tank and the mother tank by setting the mother tank at a vacuum.

In further exemplary embodiments of the present invention, setting the mother tank at the initial pressure thereof may include setting the initial pressure (P_{MT}) of the mother tank by the following equation P_{MT}=Chemical pressure due to the first height difference (h)+Push pressure of the intermediate tank. Here, the Push pressure of the intermediate tank is the pressure of a chemical solution, which is applied to the mother tank from the intermediate tank when the chemical solution occupies a certain portion of the intermediate tank.

In yet further exemplary embodiments of the present invention, setting the intermediate tank at the initial pressure thereof may include setting the initial pressure (P_{IT}) of the intermediate tank by the following equation P_{IT}=Push pressure of the intermediate tank (IT)×{V_{IT} (empty space)/VIT}. Here, the V_{IT} (empty space) is the volume of an empty space of the intermediate tank which is filled with no chemical solution, and the V_{IT} is the entire volume of the intermediate tank.

In other exemplary embodiments of the present invention, setting the bubbling tank at the initial pressure thereof may include setting the initial pressure (P_{BT}) of the bubbling tank by the following equation P_{BT}={Initial pressure (P_{IT}) of the intermediate tank (IT)−Chemical pressure due to the second height difference (h′)}×{V_{BT} (empty space)/V_{(BT+h′pipe)}}. Here, the V_{BT} is the volume of an empty space of the bubbling tank which is filled with no chemical solution, and the V_{(BT+h′pipe)} is the sum of the entire volume of the bubbling tank and the volume of a pipe between the bubbling tank and the intermediate tank.

In further exemplary embodiments of the present invention, the providing of a specific amount of chemical solution from the mother tank to the intermediate tank by maintaining the mother tank at the initial pressure of the mother tank and changing the pressure of the intermediate tank to a first pressure higher than the initial pressure of the intermediate tank may include injecting an inert gas to the mother tank so that the mother tank is maintained at the initial pressure.

In yet further exemplary embodiments of the present invention, washing a pipe between the intermediate tank and the mother tank by providing a solvent to the pipe between the intermediate tank and the mother tank may be further included.

According to exemplary embodiments of the present invention, a chemical solution may be stably supplied to a process chamber by using an intermediate buffering tank having a fixed volume. Also, because only a fixed amount of chemical solution is be supplied, the excessive supplying of the chemical solution can be prevented.

### BRIEF DESCRIPTION OF THE DRAWINGS

Exemplary embodiments of the present invention can be understood in more detail from the following description taken in conjunction with the accompanying drawings, in which:

FIG. 1 is a construction view illustrating an apparatus of supplying a chemical solution according to an exemplary embodiment of the present invention; and

FIG. 2 is a construction view illustrating a method of supplying a chemical solution according to an exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings. However, the present invention is not limited to the exemplary embodiments illustrated herein after.

### EXEMPLARY EMBODIMENT

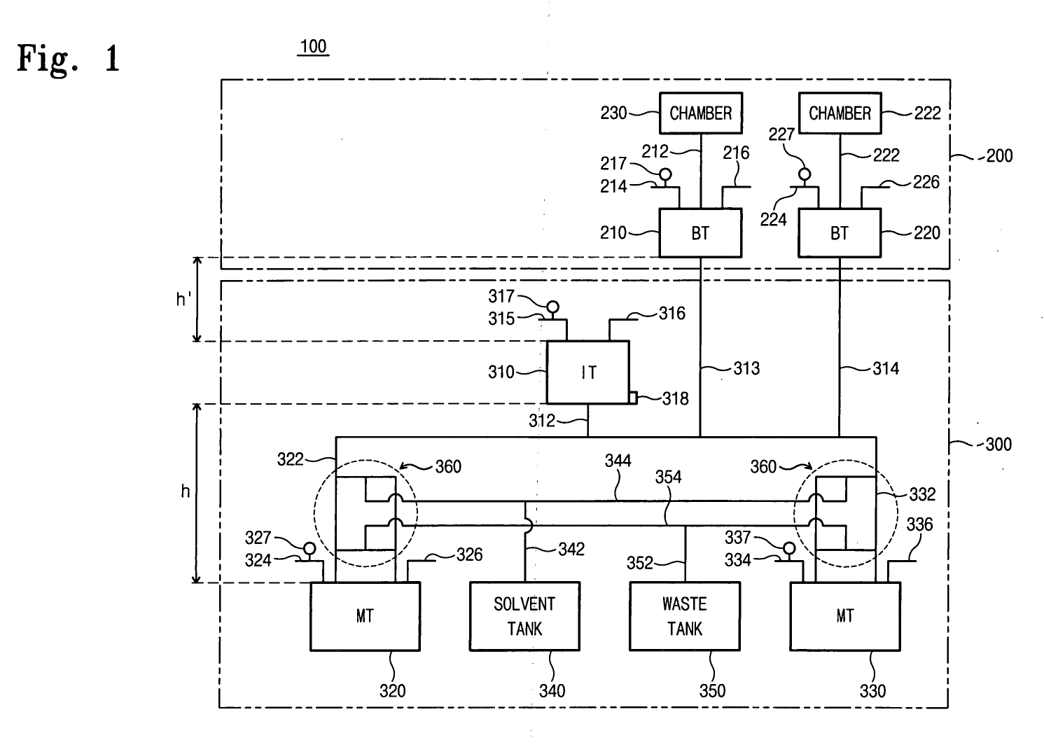

FIG. 1 is a construction view illustrating an apparatus of supplying a chemical solution according to an exemplary embodiment of the present invention.

Referring to FIG. 1, a chemical-solution supplying apparatus 200 according to an exemplary embodiment of the present invention includes mother tanks 320 and 330 storing a liquid chemical solution, bubbling tanks 210 and 220 receiving the liquid chemical solution from the mother tanks 320 and 330 and phase-changing the liquid chemical solution into a gaseous one, and one or a plurality of process chambers 230 and 240 receiving the gaseous chemical solution from the bubbling tanks 210 and 220 and in which a predetermined semiconductor process is substantially performed. To stably supply a fixed amount of chemical solution, an intermediate tank 310 serving as a buffering tank is installed between the mother tanks 320 and 330 and the bubbling tanks 210 and 220.

The mother tank 320 is installed in plurality at the same height in case of a change or addition of a chemical solution. The bubbling tanks 210 and 220 are also installed at the same height, and are connected to the process chambers 230 and 240 by pipes 212 and 222 formed of SUS (stainless steel), respectively. The pipes 212 and 222 serve as paths through which a chemical solution phase-changed into a gaseous phase is supplied, for example, a precursor such as trimethylaluminum (TMA) or tetrakismethylaminohafnium (TEMAH). An aluminum oxide layer is deposited onto a wafer loaded in the process chamber 230 by using a precursor such as TMA supplied through the pipes 212 and 222.

The aforementioned precursor of TMA or TEMAH has spontaneous combustion properties and therefore, a liquid precursor can be phase-changed into a gaseous phase more effectively by using, for example, a bubbling method adopting a bubbling. system like bubbling tanks 210 and 220 instead of using a vaporizer. Also, to supply a chemical solution by the bubbling method, an intermediate tank 310 is preferably installed that can supply a fixed amount of chemical solution and perform buffering and which also takes in account supply distance.

As precursors like TMA and TEMAH have a high corrosiveness and high reactivity, the intermediate tank 310 is preferably made of or surface-treated with a special alloy. A representative example of the special alloy includes but is not limited to a Monel™ alloy, a nickel (Ni)-copper(Cu) alloy containing small amounts of other elements like, for example, iron, manganese, or silicon thereby reducing the corrosiveness of Ni. Otherwise, if the intermediate tank 310 is neither formed of nor surface-treated with a special alloy such as a Monel™ alloy, metal impurities may thus be generated, thereby degrading the degree of purity of the chemical solution.

Pipes 322 and 332 formed of SUS and serving as paths through which a liquid chemical solution flows are installed between the mother tanks 320 and 330 and the intermediate tank 310. Also, pipes 312, 313 and 314 formed of SUS and serving as paths through which a liquid chemical solution flows are installed between the intermediate tank 310 and the bubbling tanks 210 and 220.

A pipe 324 and a vacuum pipe 326 are installed at the mother tank 320. Here, an inert gas such as, for example, nitrogen, helium, or argon is injected into the pipe 324 (hereinafter, referred to as an inert gas injection pipe), and the vacuum pipe 326 vacuumizes the mother tank 320. A pressure measuring unit such as a pressure transducer or a pressure gauge is installed at the inert gas injection pipe 324. Likewise, an inert gas injection pipe 334 and a vacuum pipe 336 are installed at another mother tank 330, and a pressure measuring unit 337 is installed at the inert gas injection pipe 334.

As in the mother tanks 320 and 330, an inert gas injection pipe 315 provided with a pressure measuring unit 317, and a vacuum pipe 316 are installed at the intermediate tank 310. Likewise, an inert gas injection pipe 214 provided with a pressure measuring unit 217, and a vacuum pipe 216 are installed at the bubbling tank 210. Also, an inert gas injection pipe 224 provided with a pressure measuring unit 227, and a vacuum pipe 226 are installed at the other bubbling tank 220.

The aforementioned process chambers 230 and 240 and the bubbling tanks 210 and 220 are installed at fabrication facility (FAB) 200. To prevent accidents in supplying a chemical solution, the intermediate tank 310 and the mother tanks 320 and 330 are preferably installed at a plenum 300 under the FAB 200. Accordingly, the mother tanks 320 and 330 are installed in the lowest position, the bubbling tanks 210 and 220 are installed in the highest position, and the intermediate tank 310 is installed at the medium height. Consequently, the mother tanks 310 and 320 and the intermediate tank 310 have a determined height difference (h), and the intermediate tank 310 and the bubbling tanks 210 and 220 have a predetermined height difference (h′).

The chemical solution supplying apparatus 100 further includes a solvent tank 340 storing a solvent, a washer washing so called dead spaces 360 near the supply pipes 322 and 332 of the mother tanks 310 and 320. The chemical solution supplying apparatus 100 further includes a waste tank 350 storing the used solvent and other wastes.

The chemical solution supplying apparatus 100 installed in the aforementioned manner may supply a fixed amount of solution by a principle of pressure equilibrium between the intermediate tank 310 and the bubbling tanks 210 and 220.

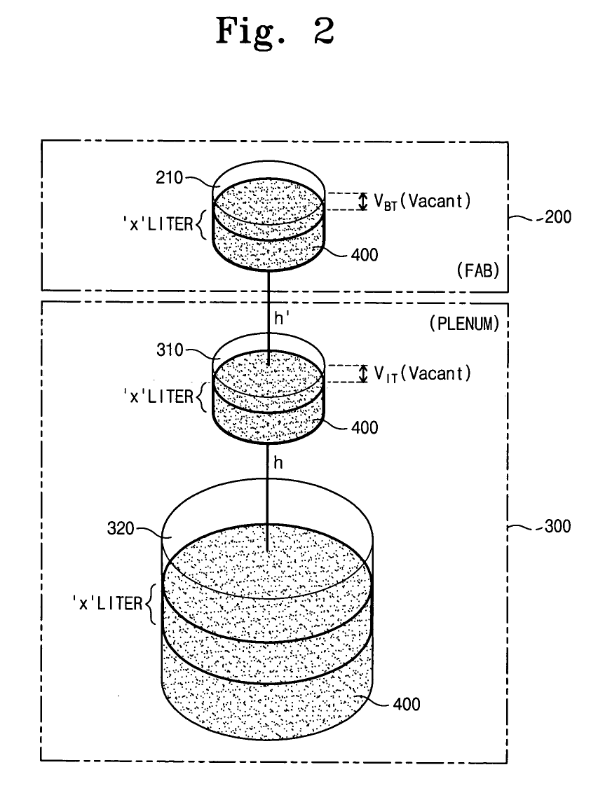

FIG. 2 is a construction view illustrating a method of supplying a chemical solution according to an exemplary embodiment of the present invention.

Referring to FIG. 2, firstly, the mother tank 320, the intermediate tank 310 and the bubbling tank 210 are set at specific initial pressures, respectively. For example, the mother tank 320 has a volume of about 4 liters (l), the intermediate tank 310 a volume of about 1 liter (l), and the bubbling tank 210 a volume of about 1 to about 2 liters. Secondly, a specific amount of chemical solution is supplied from the mother tank 320 to the intermediate tank 310 by the pressure equilibrium. Thirdly, the same amount of chemical solution as the specific amount is supplied to the bubbling tank 210 from the intermediate tank 310 by the pressure equilibrium. Lastly, the mother tank 320 is refilled with a chemical solution remaining in the pipes 312, 313 and 322 between the tanks 210, 310 and 320. The present chemical-solution supplying apparatus 100 of the present exemplary embodiment is a system that supplies a fixed amount of chemical solution by the series of the operations above.

In the first operation, the initial pressure of the mother tank 320, the intermediate tank 310 and the bubbling tank 210 are set by the following equations 1, 2 and 3, respectively.

[Equation 1]

Initial pressure (P_{MT}) of the mother tank 320=Chemical pressure by a height difference (h) between the mother tank 320 and the intermediate tank 310+Push pressure of the intermediate tank 310

The Push pressure of the intermediate tank 310 is the pressure of a chemical solution 400, which is applied to the mother tank 320 from the intermediate tank 310 when the chemical solution 400 occupies a certain portion of the intermediate tank 310. The initial pressure (P_{MT}) of the mother tank 320 is set by injecting an inert gas (e.g., argon) through the pipe 324. For example, the initial pressure (P_{MT}) of the mother tank 320 is set at about 405 kPa.

[Equation 2]

Initial pressure (P_{IT}) of the intermediate tank 310=Push pressure of the intermediate tank 310×{V_{IT} (empty space)/V_{IT}}

The V_{IT} (empty space) is the volume of an empty space of the intermediate tank 310 which is not filled with a chemical solution 400, and the V_{IT} is the entire volume of the intermediate tank 310. For example, the initial pressure (P_{IT}) of the intermediate tank 310 is set at about 85 kPa.

[Equation 3]

Initial pressure (P_{BT}) of the bubbling tank (BT)={Initial pressure (P_{IT}) of the intermediate tank 310−Chemical pressure by the height difference (h′) between the intermediate tank 310 and the bubbling tank 210}×{V_{BT}(empty space)/V_{(BT+h′pipe)}}

The V_{BT} (empty space) is the volume of an empty space of the bubbling tank 210 which is not filled with a chemical solution 400, and V_{(BT+h′ pipe)} is the sum of the entire volume of the bubbling tank 210 and the volume of the pipe 312 and 313 between the bubbling tank 210 and the intermediate tank 310. For example, the initial pressure (P_{BT}) of the bubbling tank 210 is set at about 10 kPa.

In the second operation, the pressure of the mother tank 320 is continuously maintained at about 405 kPa, which is the initial pressure of the mother tank 320, and ‘x’ liters (l) of chemical solution 400 stored in the mother tank 320, e.g., about 0.4 l of solution, is supplied to the intermediate tank 310. The pressure of the intermediate tank 310 increases from its initial pressure (e.g., 85 kPa) to about 400 kPa.

In the third operation, as the pressure of the intermediate tank 310 is higher than that of the bubbling tank 210, ‘x’ liters of chemical solution 400, namely, about 0.4 l of solution, is supplied to the bubbling tank 210 from the intermediate tank 310 by the pressure difference. In this case, the pressure of the intermediate tank 310 decreases from about 400 kPa to about 85 kPa, the initial pressure of the intermediate tank 310, and the pressure of the bubbling tank 210 increases to about 40 kPa from about 10 kPa, the initial pressure of the bubbling tank 210. A liquid chemical solution 400 provided to the bubbling tank 210 is phase-changed to a gaseous chemical solution in the bubbling tank 210, and then the gaseous chemical solution 400 is provided to the process chamber 230, so that a predetermined semiconductor process is performed.

In the fourth operation, even though a chemical solution 400 is provided to the bubbling tank 210 from the intermediate tank 310, a chemical solution still remains in the pipes 312 and 313 between the intermediate tank 310 and the bubbling tank 210. As a chemical solution staying in the pipes 312 and 313 may generate particles, the pressure of the intermediate tank 310 is changed from its initial pressure of about 85 kPa to a vacuum level. Then, the chemical solution within the pipes 312 and 313 flows into the intermediate tank 310, and the pressure of the bubbling tank 210 decreases from about 40 kPa to about 7 kPa. Thereafter, the pressure of the mother tank 320 is lowered to a vacuum level. Then, the mother tank 320 is refilled with the chemical solution introduced to the intermediate tank 310 and thus, the pressure of the mother tank 320 becomes about 7 kPa. Then, the mother tank 320 is refilled with chemical solutions staying in the pipes 312, 313 and 322 between the tanks 210, 310 and 320.

The pressures of the tanks 210, 310 and 320 according to the series of operations above are represented in Table 1 below, respectively. Here, the pressure is expressed in kPa.

TABLE 1

| | First operation | | | |
|---|---|---|---|---|
| | (initial pressure | Second | Third | Fourth |
| Category | setting) | operation | operation | operation |
| Pressure of | 405 | 405 | — | 7 |
| mother tank 320 | | | | |
| Pressure of | 85 | 400 | 85 | — |
| intermediate tank | | | | |
| 310 | | | | |
| Pressure of | 10 | — | 40 | 7 |
| bubbling tank 210 | | | | |

Through the above series of operations, only a desired amount of chemical solution is supplied based upon a pressure equilibrium condition. With this pressure equilibrium condition, the chemical solution begins to flow due to the pressure differences between the tanks 210, 310 and 320 until the flow of the chemical solution is stopped due to the pressure equilibrium.

The volume of the intermediate tank 310 may be selected in various manners depending on the amount of chemical solution to be supplied and the working ratio of process equipment. Like the aforementioned example, when the volume of the intermediate tank 310 is set to about 1 liter (l), the intermediate tank 310 functions as an intermediate buffering tank. Accordingly, the intermediate tank 310 having a fixed volume functions as a safety device that can prevent accidents due to an excessive supply of a chemical solution, which is caused when a chemical solution with a volume greater than the fixed volume is conveyed. Also, the intermediate tank 310 serves to reduce a fixed-amount supply error. When a large amount of chemical solution is conveyed, the aforementioned series of operations is repetitively performed, so as to prevent an excess of the chemical solution from being supplied.

A process of washing the pipes 322 and 332 using a solvent stored in the solvent tank 340 may be performed before and after the chemical-solution supplying process. In the washing process, a solvent from the solvent tank 340 washes the pipes 322 and 332 within dead spaces 360 through the pipes 342 and 344. The solvent discarded after the washing process, and other foreign substances are stored in a waste tank 350 and then discarded.

According to exemplary embodiments of the present invention, the installation of an intermediate buffering tank may contribute to securing the stability of a chemical-solution supply. Also, because an intermediate buffering tank having a fixed volume is used to supply only a fixed amount of chemical solution, process accidents or accidents due to excessive supply of a chemical solution can be prevented from occurring.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. An apparatus for supplying a chemical solution, comprising:
a mother tank storing a chemical solution;
an intermediate tank disposed in a higher position than the mother tank with a first height difference (h), the intermediate tank being adapted to receive a fixed amount of chemical solution from the mother tank; and
a bubbling tank disposed in a higher position than the intermediate tank with a second height difference (h′), the bubbling tank being adapted to receive the fixed amount of the chemical solution from the intermediate tank.

2. The apparatus of claim 1, wherein an initial pressure (P_{MT}) of the mother tank (MT) is set by the following equation,
P_{MT}=Chemical pressure due to the first height difference (h)+Push pressure of the intermediate tank (IT),
wherein the Push pressure of the intermediate tank (IT) is the pressure of a chemical solution, which is applied to the mother tank (MT) from the intermediate tank (IT) when the chemical solution occupies a certain portion of the intermediate tank (IT)

3. The apparatus of claim 2, wherein an initial pressure (P_{IT}) of the intermediate tank (IT) is set by the following equation,
P_{IT}=Push pressure of the intermediate tank (IT)×{V_{IT} (empty space)/V_{IT}},
wherein the V_{IT} (empty space) is a volume of an empty space of the intermediate tank (IT) which is filled with no chemical solution, and the V_{IT} is an entire volume of the intermediate tank (IT)

4. The apparatus of claim 3, wherein an initial pressure (P_{BT}) of the bubbling tank (BT) is set by the following equation,
P_{BT}={Initial pressure (P_{IT}) of the intermediate tank (IT)−Chemical pressure due to the second height difference (h′)}×{V_{BT} (empty space)V_{(BT+h′pipe)}},
wherein the V_{BT} is a volume of an empty space of the bubbling tank (BT) which is filled with no chemical solution, and the V_{(BT+h′pipe)} is the sum of an entire volume of the bubbling tank (BT) and a volume of a pipe between the bubbling tank (MT) and the intermediate tank (IT)

5. The apparatus of claim 1, further comprising a first pipe disposed between the intermediate tank (IT) and the bubbling tank (BT), for refilling the intermediate tank with a chemical solution from within the first pipe.

6. The apparatus of claim 1, further comprising a second pipe disposed between the mother tank (MT) and the intermediate tank (IT) for refilling the mother tank with a cleaning solution from within the second pipe.

7. The apparatus of claim 6, further comprising a solvent tank storing a solvent for washing the second pipe.

8. The apparatus of claim 7, further comprising a waste tank storing a solvent to be discarded after washing the second pipe.

9. The apparatus of claim 1, wherein the chemical solution comprises one of TMA (trimethylaluminum) and TEMAH (tetrakismethylaminohafnium).

10. The apparatus of claim 1, wherein the intermediate tank (IT) includes a pipe through which an inert gas is supplied thereto so that the pressure of the intermediate tank (IT) increases.

11. The apparatus of claim 10, wherein the pipe includes a unit that measures the pressure of the intermediate tank (IT).

12. The apparatus of claim 10, wherein the intermediate tank (IT) includes an ultrasonic sensor that checks whether or not a chemical solution exists.

13. The apparatus of claim 10, wherein the intermediate tank (IT) is formed of or surface-treated with an alloy comprising nickel (Ni) and copper (Cu).

14. The apparatus of claim 1, wherein at least one of the mother tank (MT) and the bubbling tank (BT) is at least formed in plurality.

15. A method of supplying a chemical solution using a mother tank storing a chemical solution, an intermediate tank disposed in a higher position than the mother tank with a first height difference (h), and a bubbling tank disposed in a higher position than the intermediate tank with a second height difference (h′), the method comprising:
setting the mother, intermediate and bubbling tanks at respective initial pressures;
providing a specific amount of chemical solution from the mother tank to the intermediate tank by maintaining the mother tank at the initial pressure of the mother tank and changing the pressure of the intermediate tank to a first pressure higher than the initial pressure of the intermediate tank;
providing the specific amount of chemical solution from the intermediate tank to the bubbling tank by changing the pressure of the intermediate tank from the first pressure to the initial pressure of the intermediate tank and changing the pressure of the bubbling tank to a second pressure higher than the initial pressure of the bubbling tank;
refilling the intermediate tank with a chemical solution existing in a pipe between the bubbling tank and the intermediate tank by changing the pressure of the bubbling tank to a third pressure lower than the second pressure and by setting the intermediate tank at a vacuum; and
refilling the mother tank with a chemical solution existing in a pipe between the intermediate tank and the mother tank by setting the mother tank at a vacuum.

16. The method of claim 15, wherein respectively setting the tanks at the initial pressures comprises:
setting the initial pressure (P_{MT}) of the mother tank by the following equation,
P_{MT}=Chemical pressure due to the first height difference (h)+Push pressure of the intermediate tank,
wherein the Push pressure of the intermediate tank is a pressure of a chemical solution, which is applied to the mother tank from the intermediate tank when the chemical solution occupies a certain portion of the intermediate tank

17. The method of claim 16, respectively setting the tanks at the initial pressures comprises:
setting the initial pressure (P_{IT}) of the intermediate tank by the following equation,
P_{IT}=Push pressure of the intermediate tank (IT)×{V_{IT} (empty space)/V_{IT}},
wherein the V_{IT} (empty space) is a volume of an empty space of the intermediate tank which is filled with no chemical solution, and the V_{IT} is an entire volume of the intermediate tank

18. The method of claim 17, wherein respectively setting the tanks at the initial pressures comprises:
setting the initial pressure (P_{BT}) of the bubbling tank by the following equation,
P_{BT}={Initial pressure (P_{IT}) of the intermediate tank (IT)−Chemical pressure due to the second height difference (h′)}×{V_{BT} (empty space)/V_{(BT+h′pipe)}},
wherein the V_{BT} is a volume of an empty space of the bubbling tank which is filled with no chemical solution, and the V_{(BT +h′pipe)} is the sum of an entire volume of the bubbling tank and a volume of a pipe between the bubbling tank and the intermediate tank

19. The method of claim 15, wherein providing a specific amount of chemical solution from the mother tank to the intermediate tank by maintaining the mother tank at the initial pressure of the mother tank and changing the pressure of the intermediate tank to a first pressure higher than the initial pressure of the intermediate tank, comprises:
injecting an inert gas to the mother tank so that the mother tank is maintained at the initial pressure of the mother tank.

20. The method of claim 15, further comprising:
washing the pipe between the intermediate tank and the mother tank by providing a solvent to the pipe between the intermediate tank and the mother tank.
